(19) United States
(12) Patent Application Publication
(10) Pub. No.: US 2026/0036206 A1
(43) Pub. Date: Feb. 5, 2026

(54) ANNULAR SHAFT SEAL WITH LEAKAGE DETECTOR

(71) Applicant: AKTIEBOLAGET SKF, GOTEBORG (SE)

(72) Inventors: Andreas Clemens VAN DER HAM, Warnsveld (NL); Mario STEFAN, Poppenlauer (DE); Galid ARROUD, Utrecht (NL); Rob ZIMMERMANN, Utrecht (NL)

(21) Appl. No.: 19/276,052

(22) Filed: Jul. 22, 2025

(30) Foreign Application Priority Data
Jul. 30, 2024 (EP) 24191882.0

(51) Int. Cl. F16J 15/3296; G01M 3/16

(52) U.S. Cl. CPC F16J 15/3296; G01M 3/165

(57) ABSTRACT

An annular shaft seal includes an annular housing supporting or defining at least one seal element configured to form a seal with a counter surface of a rotatable shaft in the housing and a leakage detector comprising a sensor and a controller, at least part of the sensor being located in or in fluid communication with a chamber defined in part by the counter surface and in part by the seal element. The sensor is formed from first and second bodies of different metals having different anodic indexes, and the controller is operatively connected to the sensor and configured to detect a voltage between the first body and the second body and/or detect a resistance between first body and the second body and/or detect a current between the first body and the second body and/or detect a conductance between the first body and the second body.

### CROSS-REFERENCE

This application claims priority to European patent application no. 24191882.0 filed on Jul. 30, 2025, the contents of which are fully incorporated herein by reference.

### TECHNOLOGICAL FIELD

The disclosure concerns a device with a first space and a first seal, which seals the first space from a second space and more specifically, to an annular shaft seal having a leakage detector.

### BACKGROUND

An issue is that water in various states (e.g. it can be in its dissolved, emulsified or free state within the lubricant) can progressively accumulate unnoticed inside a mechanical system (e.g. due to unexpected seal failure). This will provoke issues as it is a hidden threat to the system (e.g. causing corrosion, excessive wear and hydrogen embrittlement) that goes undetected until real problems arise, such as malfunctioning or failure of the mechanical system. A direct consequence is that one is forced to interrupt the asset's operation to carry out a reactive maintenance. All of this leads to a sudden increase in the asset's total cost of ownership, which can be in some cases substantially high (e.g. offshore installations).

The Karl Fischer titration measurement procedure is a standardized analysis procedure (although requiring specific measurement equipment) that can trace the amount of water in grease samples. Yet, one of the major bottlenecks with this offline approach is that the application needs to be paused to take out grease samples to analyze them in a laboratory.

The document WO 2014/094812 A1 discloses a bearing with a seal, which seals a space of the bearing from a further space. A method of condition monitoring of grease is described. The documents WO 2014/094813 A1, US 2018 238 851 and US 2018 038 417 describe further related prior art.

Furthermore, especially in the case of applications with high-value assets, seal systems (either in single or multiple seal configuration) are being overconfigured to delay water ingress, hence, minimizing the risk of the contaminant reaching the application's critical space. Another approach is to perform preventive maintenance long before the seal is expected to fail; however, this comes at a great financial cost.

### SUMMARY

An aspect of the disclosure is to provide efficient protection against damage caused by liquid ingress. The disclosure relates a device with a first space and a first seal that seals the first space from a second space.

The device comprises two metal regions, which are located in the first space, and a control unit (sometimes referred to as a “controller”), which is configured to measure a voltage between the metal regions and/or a resistance between the metal regions and/or a current between the metal regions and/or a conductance between the metal regions, wherein the two metal regions are made from different metals and/or the device comprises a conductive route from one of the two metal regions to the other of the two metal regions which runs at least in two different metals. By the fact that the route “runs at least in two different metals”, it should be understood in particular that one part of the route is made from a first metal and a second part of the route is made from a second metal, which is different from the first metal. This arrangement provides efficient protection against damage caused by liquid ingress. In particular, a change in the voltage and/or the current and/or the resistance and/or the conductance can be used to notice the presence of a liquid caused by a failure of the seal.

In particular, the control unit can comprise a processor (e.g. a computer processor (CPU=central processing unit), an application-specific integrated circuit (ASIC), an integrated circuit, a computer, a system-on-a-chip (SOC), a programmable logic element, or a field programmable gate array (FGPA) or a microprocessor) and memory, in which an operating program is saved. In particular, the control unit can comprise one or more sensors.

Advantageously, the metal regions are spaced apart from each other and the control unit is configured to create an alarm signal when the voltage between the metal regions and/or the current reaches or surpasses a predetermined value. Thereby a signal can be created when a certain liquid is present between the metal regions.

Furthermore, the predetermined value may depend on a difference of an anodic index of the different metals. Through this the presence of water between the metal regions can be recognized.

Advantageously the control unit is configured to create a signal when the resistance reaches or surpasses a predetermined resistance value and/or the conductance reaches or falls below a predetermined conductance value. Thereby a deterioration of one of the metals due to the presence of an electrolyte can be noticed. In particular, the electrolyte can be water.

Moreover, at least one of the metal regions has a shape of a ring or a ring segment. Through this an interaction between this metal region and a liquid can take place in a relatively large area, which means that a presence of a liquid can also be recognized in this relatively large area.

Advantageously, the first seal may be part of a second seal of the device. Thereby a failure of the first seal can be detected at a time when the second seal still functions partially.

Furthermore, the different metals from which the two metal regions are made have different anodic indices. Thereby a voltage, which can be detected, is created when a space between the two metal regions is filled with water.

Moreover, the two different metals have different anodic indices. Through this detectable change of a resistance of one of the metals happens when water is in contact with the metals.

Advantageously, at least one of the metal regions and/or the control unit are integrated into the first seal and/or into a second seal of the device. Thereby the device can be built with a low number of components.

Advantageously an insulator, which is a solid, is located between the two metal regions. Thereby a contact between the two metal regions is safely avoided.

Moreover, a device, in particular as described above, with a first space and a seal that seals the first space from a second space, is provided, wherein at least one sensor, which is configured to detect at least one liquid and which is at least partially located within the seal. Through this arrangement, efficient protection against damage caused by liquid ingress can be provided. In particular, liquid can be detected in an early stage.

Furthermore, the sensor is preferably a capacitive sensor. Through this a high sensitivity and a fast response time can be achieved.

An aspect of the disclosure comprises an annular shaft seal having an annular housing supporting or defining at least one seal element configured to form a seal with a counter surface of a rotatable shaft in the housing and a leakage detector comprising a sensor and a controller. At least part of the sensor is located in or in fluid communication with a chamber that is defined in part by the counter surface and in part by the at least one seal element. The sensor comprises a first body of a first metal having a first anodic index and a second body of a second metal different than the first metal and having a second anodic index different from the first anodic index, and the controller is operatively connected to the sensor and configured to detect a voltage between the first body and the second body and/or detect a resistance between first body and the second body and/or detect a current between the first body and the second body and/or detect a conductance between the first body and the second body.

Further advantages can be seen in the following description of the drawings. Embodiments of the disclosure are shown in the drawings. The drawings, the description and the claims contain numerous features in combination. The skilled person will expediently also consider the features individually and combine them to form useful further combinations.

### BRIEF DESCRIPTION OF THE DRAWINGS

FIG. 1 is an axial sectional view through a device according to an embodiment of the disclosure.

FIG. 2 is an enlarged detail view of a portion of FIG. 1.

FIG. 3 is an enlarged detail view of a portion of FIG. 2.

FIG. 4A is a perspective view of a carrier and parts carried by the carrier.

FIG. 4B is an enlarged detail view of a portion of the carrier of FIG. 4A.

FIG. 5 is an axial elevation view looking in the direction of line V-V in FIG. 1.

FIG. 6 is a schematic view of a straight wire that can be used with embodiments of the present disclosure.

FIG. 7 is a perspective view of a portion of an alternative embodiment of a sensor according to an embodiment of the present disclosure.

### DETAILED DESCRIPTION

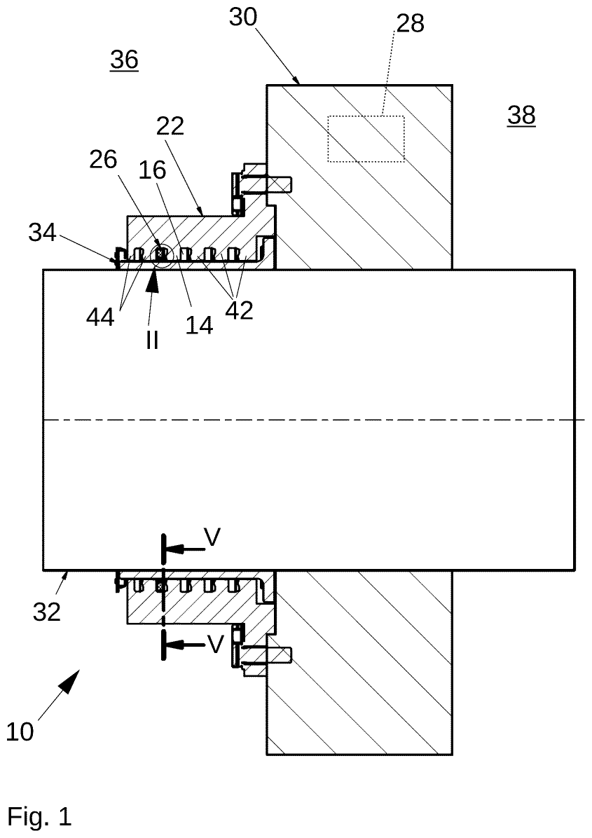

FIG. 1 is a partial axial section through a device 10 according to the disclosure, which comprises a housing 30, a liner 34 and a shaft 32, which is configured to rotate relative to the housing. The liner 34 is fixed to the shaft in a liquid-tight way. The device compromises a first seal 14 and a second seal 22. The first seal 14 is a part of the second seal 22. The second seal is fixed to the housing 30 in a liquid-tight way and seals a space 36 of the device against a space 38, which is outside of the device, by providing a seal function between the housing 30 and the liner 34. Alternatively, the liner can be omitted and the seal function can be provided between the housing and the shaft.

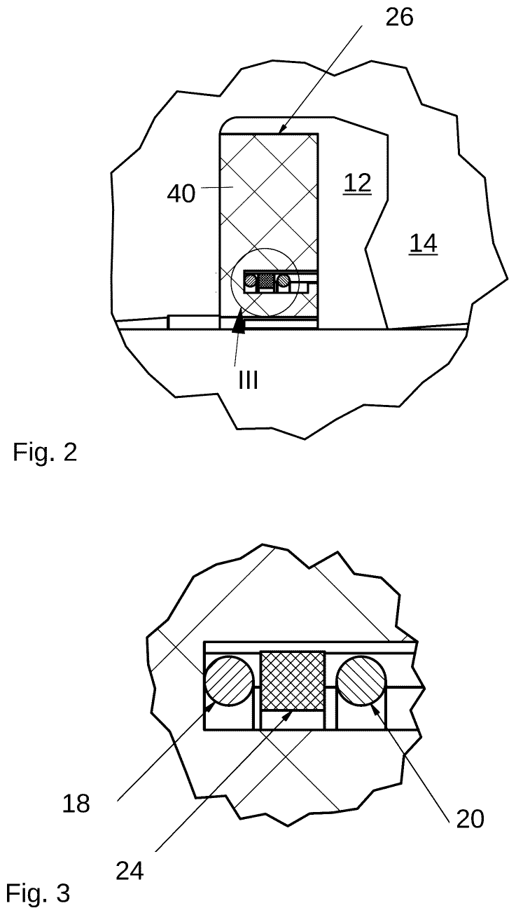

The first seal 14 seals a space 12 of the device against space 16 of the device. Each of the spaces 12, 16 is a chamber of the seal 22. The seal 14 abuts against the liner 34. Alternatively, the seal 14 and the liner 34 form a gap ring. The device comprises two metal regions 18, 20 (FIGS. 2 and 3), which are located in the space 12. Each of the metal regions comprises a wire and has a shape of a ring segment, which is almost a complete ring. The ring segments have the same diameter. Moreover, the device comprises an insulator 24, which is located between the two metal regions 18, 20 and which is a solid. The insulator 24 has the same shape and the same diameter as the metal regions. The metal regions and the insulator surround the shaft almost completely in the circumferential direction of the shaft. The device also comprises a carrier 40, which carries the metal regions and the insulator in a way such that the metal regions and the insulator have contact to the part of the space 12, which is outside of the carrier 40. The carrier 40 is located in the space 12. Together the carrier 40, the metal regions and the insulator form a sensor 26.

Furthermore, the device comprises a control unit (controller) 28, which is configured for measuring a voltage between the metal regions. The two metal regions are made from different metals that have different anodic indices. For example, the metal region 18 can comprise zinc or tin and the metal region 20 can comprise copper. The metal regions 18, 20 are spaced apart from each other. The control unit 28 is configured to create a signal when the voltage between the metal regions reaches or surpasses a predetermined value. The predetermined value depends on a difference of an anodic index of the different metals. For example, the predetermined value can be the difference of the anodic indices of the different metals minus 20% of this difference. When the metal region 18 comprises zinc and the metal region 20 comprises copper, the following happens, when the metal regions are connected with water:

At the zinc-electrode, an oxidation reaction takes place: Zn(s)→Zn²⁺+2 e⁻; yielding an oxidation potential E⁰=−0.76 V. At the copper-electrode, a reduction reaction takes place: Cu²⁺+2e⁻→Cu (aq); yielding a reduction potential E⁰=0.16 V. In practice, the voltage difference between the electrodes is slightly lower than the calculated value.

The seal 22 comprises further seals 42 which take part in sealing the space 36 from the space 38. If the seals 42 fail, water will intrude into the space 12 if the space 38 contains water. If the metal regions are connected by water, voltage between the metal regions builds up and the control unit will create a signal that indicates to a user of the device via a display and/or via an acoustic noise that water is inside the space 12. When water is inside the space 12, seals 44, which are a part of the seal 22, can still function and provide a seal between space 36 and space 38. Each of the seals 44 abuts against the liner 34 or builds a gap ring with the liner.

Optionally further sensors, which are identical in construction with the sensor 26, can be put in a chamber between the seals 44 and/or in chambers between the seals 42. The further sensors can work together with the control unit in the same way as the sensor 26.

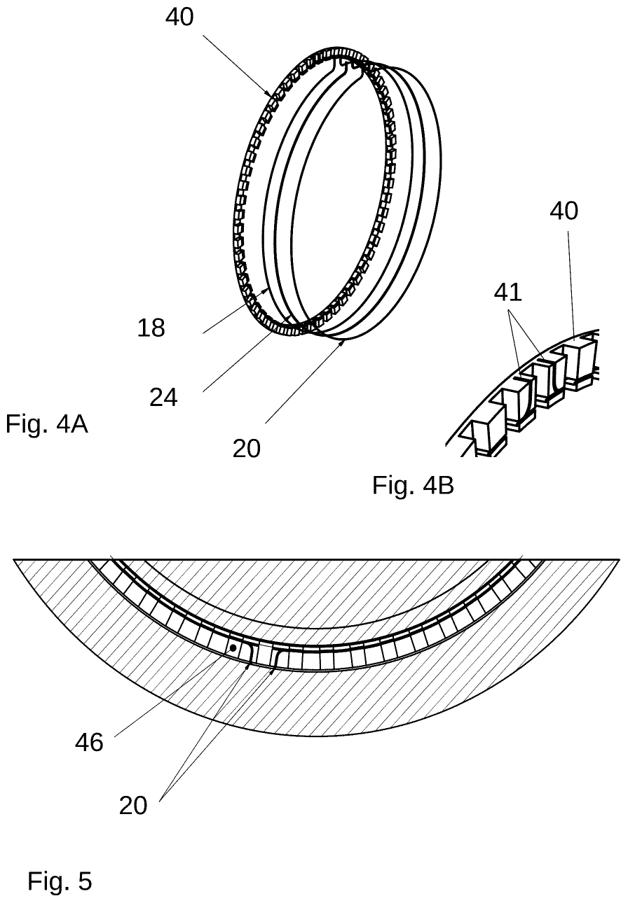

FIG. 4A shows the sensor 26 in an exploded view.

FIG. 5 shows a section as indicated in FIG. 1. Viewed in an axial direction of the shaft the carrier 40 contains gaps 46 in the wire support. Ends 48 of the metal region 20 are connected to the control unit.

It is possible to provide the device with further sensors which are identical in construction with the sensor 26, wherein one of the sensors can be located between neighboring seals of the seal 22. Then the device can comprise five sensors. It is also possible to equip each chamber of the seal 22 with multiple of the sensors. The progression of wear can be monitored. This allows for seal replacement before total degradation of the seal system and to extend the service life of the seal. By monitoring the degradation, the right moment in time can be chosen when to replace the seal. The control unit can be connected to a monitoring system. This can be a monitoring system of an arrangement, which contains the device.

The sensor can either be integrated or placed into the seal 22 and/or into the seal 14. For example, more than fifty percent or more than 75 percent of the surfaces of the metal regions 18, 20 can touch the seal 22 and/or the seal 14. The metal regions 18, 20 can be directly fixed to the seal 22 or to the seal 14. Furthermore, the control unit 28 can be fixed to the seal and/or can be located within the seal 22.

The disclosure presents a cost and energy effective solution to inform the owner if water has leaked into the system so that appropriate actions can be taken in a timely manner. An advantage is that with the ability to detect water leakage, the service life can be increased. Extending the service life reduces the operational cost for the end user. In principle, water leakage sensing can be fitted to any seal system, provided that there is enough space. This can be used to at least detect the fact of leakage and invoke activities that would avoid more consequential damage.

The simplicity of the working principle behind this disclosure will allow to equip various types of mechanical systems (across many industries) with a method for detecting water ingress. Furthermore, the method is not limited by the application's size, hence, it is scalable. Especially given the fact that the method requires a relatively low investment cost (material resource) and is energy efficient (i.e. passive detection method). The length of the electrodes can be adapted to the size of the application.

Yet another advantage of the present disclosure is its positive impact on the asset's maintenance management and how it changes it for the better. More specifically, having a look at the current situation: when there is a seal barrier in the mechanical system, its unknown condition forces the asset's owner to either execute periodic maintenance according to a fixed schedule (also known as preventive maintenance) or do as soon as possible reactive maintenance (immediate repair/replacement) in case an unexpected failure occurs to the system. In both cases, the consequence is that the maintenance cost is substantially high and weighs on the asset's total cost of ownership since there is no sensor unit informing the asset's owner on the occurrence of water ingress into the system. This is especially true in case the asset is difficult to access, e.g. offshore installations.

Now, the present disclosure will allow to improve the approach for managing the asset's maintenance resulting in maximizing the asset's life. For example, in case there is a single seal in the mechanical system, then the asset owner is at least informed by the sensor that water ingress is happening so that a decision can be taken on time to take the necessary actions, hence, minimizing the chance of major damage happening to the asset. In case of multiple seals forming a seal barrier within the mechanical system, then multiple sensor units can be smartly positioned within the available spaces of the seal system. This gives an advantage to the asset's owner to align/correct the timing of the scheduled maintenance if water ingress happens. More specifically, one of the sensor units will alert the asset's owner if water is leaking past the first seal of the seal system. This entails, for example, that a decision can be made to not react immediately to not interfere with the asset's operation since it can still safely operate until the next planned maintenance since there are still multiple seals that are being monitored by the placed sensors.

Another potential advantage of the present disclosure is that the scope of the sensing method can be potentially enlarged to monitor the ingress of other types of liquid contaminants (besides water) in mechanical systems by selecting appropriate electrode materials.

All by all, an important advantage is that this disclosure allows the asset's owner to have a first insight/indication (although indirectly) on the ingress of water in a mechanical system. This alone will lead to optimizing the asset's life while having more grip (i.e. lowering) its total cost of ownership.

The device can for example be a part of a marine vessel or a tidal turbine. The seal 22 can for example protect a bearing located in the space 36, from water.

Since the metal regions 18, 20 are almost a ring, they have a large surface area, which means that the risk that they are completely covered by grease (this could impact the functioning of the device) is low.

The ends of the metal regions 18, 20 can run in channels 41 within the carrier radially outwardly towards the control unit (FIGS. 4A and 4B). The carrier can be made from two halves, which are rings and clipped together.

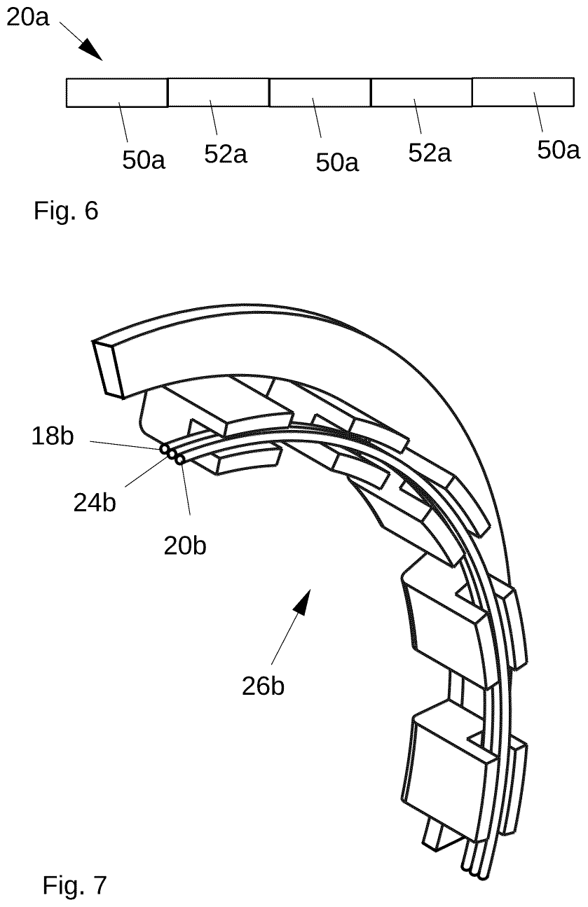

FIGS. 6 and 7 show alternative embodiments. Components, features and functions that are essentially the same are generally numbered with the same reference signs. However, the letters “a” or “b” have been added to the reference numerals of these alternative embodiments in FIG. 6 and FIG. 7 to differentiate between the embodiments. The following description is essentially limited to the differences to the embodiment in FIG. 1 to FIG. 5, whereby reference can be made to the description of the embodiment in FIG. 1 to FIG. 5 with regard to components, features and functions that remain the same.

A further embodiment of the disclosure deviates from the embodiment shown in the FIGS. 1 to 5 through the following: the metal region 18 and the insulator 24 is not present. The metal region 20a (FIG. 6), which is a wire, comprises segments 50a and segments 52a, which are strung together in an alternate way: after each segment 50a a segment 52a is located and touches this segment 50a and after each segment 52a a segment 50a is located and touches this segment 52a. Neighboring segments are fixed to each other in a conductive way. The segments 50a comprise a first metal. The segments 52a comprise a second metal, which is different from the first metal. The two different metals have two different anodic indices. For example, the segments 50a comprise copper and the segments 52a comprise zinc. The control unit 28 measures the conductance between the ends of the metal region 20a, which means between the ends of the wire. When the wire is exposed to water, the conductance of the wire deteriorates. The zinc corrodes. The control unit is configured to create a signal, when the conductance reaches or falls below a predetermined conductance value. A variation of this embodiment is to create the metal region 20a differently: For example, by winding a zinc wire around a copper wire.

FIG. 7 shows a section of an alternative embodiment of a sensor 26b. The sensor 26b is also ring shaped.

An even further embodiment of the disclosure has a sensor 26 as shown in FIG. 1, which means, the sensor 26 is located within the seal 22. This embodiment deviates from the embodiment shown in the FIGS. 1 to 5 through the following: the sensor 26 is capacitive sensor. When water intrudes in the space 12, the capacitive sensor senses this. Since the capacitive sensor is connected with the control unit 28, the control unit creates a signal, when the capacitive sensor senses the water.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved leakage detectors for seals.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. An annular shaft seal comprising:
an annular housing supporting or defining at least one seal element configured to form a seal with a counter surface of a rotatable shaft in the housing, and
a leakage detector comprising a sensor and a controller, at least part of the sensor being located in or in fluid communication with a chamber defined in part by the counter surface and in part by the at least one seal element,
wherein the sensor comprises a first body of a first metal having a first anodic index and a second body of a second metal different than the first metal and having a second anodic index different from the first anodic index, and
wherein the controller is operatively connected to the sensor and configured to detect a voltage between the first body and the second body and/or detect a resistance between first body and the second body and/or detect a current between the first body and the second body and/or detect a conductance and/or a capacitance between the first body and the second body.

2. The annular shaft seal according to claim 1,
the first body is spaced from the second body by an air-filled gap, and
the controller is configured to generate an alarm signal when the voltage or the resistance or the current or the capacitance reaches a predetermined value.

3. The annular shaft seal according to claim 1,
wherein the first body and/or the second body have a shape of a ring or a ring segment.

4. The annular shaft seal according to claim 1,
wherein the controller is integrated into the at least one seal element.

5. The annular shaft seal according to claim 1,
including a solid an insulator interposed between the first body and the second body.

6. The annular shaft seal according to claim 1,
wherein the controller is operatively connected to the sensor and configured to detect the capacitance between the first body and the second body.

7. An annular shaft seal comprising:
an annular housing supporting at least one seal element configured to form a seal with a counter surface of a rotatable shaft in the housing, and
a leakage detector comprising a sensor and a controller, at least part of the sensor being located in or in fluid communication with the chamber,
wherein the sensor comprises a first body of a first metal and a second body of a second metal different than the first metal, and
wherein the controller is operative connected to the sensor and configured to detect a change in a voltage between the first body and the second body and/or detect a change in a resistance between first body and the second body and/or detect a change in a current between the first body and the second body and/or detect a change in a conductance between the first body and the second body, and/or detect a change in a capacitance between the first body and the second body.

8. The annular shaft seal according to claim 7,
the first body is spaced from the second body by an air-filled gap, and
the controller is configured to generate an alarm signal when the change in the voltage or in the resistance or the in current or in the capacitance reaches a predetermined value.

9. The annular shaft seal according to claim 7,
wherein the first body and/or the second body have a shape of a ring or a ring segment.

10. The annular shaft seal according to claim 7,
wherein the controller is integrated into the at least one seal element.

11. The annular shaft seal according to claim 7,
including a solid an insulator interposed between the first body and the second body.

12. The annular shaft seal according to claim 7,
wherein the controller is configured to detect a change in the capacitance between the first body and the second body.
